(19) United States
(12) Patent Application Publication
(10) Pub. No.: US 2024/0098632 A1
(43) Pub. Date: Mar. 21, 2024

(54) System and Method for Connecting to a Target Access Point

(71) Applicant: ZEBRA TECHNOLOGIES CORPORATION, Lincolnshire, IL (US)

(72) Inventors: Venkateswaran Narayanan, Bangalore (IN); Sethuraman Vijayakumar, Madurai (IN); Kannan J, Udangudi (IN); Anandakumar Gopalsamy, Ronkonkoma, NY (US); Ambika Nagarajaiah, Bangalore (IN); Dayal Madhukar Rai, Bangalore (IN)

(21) Appl. No.: 17/945,595

(22) Filed: Sep. 15, 2022

(51) Int. Cl. H04W 48/20; H04W 76/15; H04W 76/36

(52) U.S. Cl. CPC H04W 48/20; H04W 76/15; H04W 76/36

(57) ABSTRACT

An example computing device includes: a wireless communications interface configured to connect to a network deployed by one or more access points; a controller for the wireless communications interface, the controller configured to: predict whether a target access point for connecting to the network has an active session with the computing device when the computing device is disconnected from the target access point; when the uncleared session is predicted, send a clearing request to the target access point to clear the active session; and connect to the target access point.

### BACKGROUND

Wireless networks may be serviced by several access points to which devices can connect based on their location within the wireless network. Sometimes, network or connectivity issues may cause a device to lose connection to an access point without clearing its active session at the access point. When the device attempts to reconnect, the access point may identify the active session and initiate an association comeback timer, during which connection requests from the device are rejected. This may cause an increased delay in reconnecting to the network.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic diagram of a system for connecting to a target access point.

FIG. 2 is a block diagram of certain internal hardware components of the computing device of FIG. 1.

FIG. 3 is a flowchart of a method for connecting to a target access point.

FIG. 4 is a flowchart of a method of predicting an active session at the target access point at block 310 of the method of FIG. 3.

FIG. 5 is a schematic diagram of an example performance of block 315 of the method of FIG. 3.

FIG. 6 is a schematic diagram of another example performance of block 315 of the method of FIG. 3.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a computing device comprising: a wireless communications interface configured to connect to a network deployed by one or more access points; a controller for the wireless communications interface, the controller configured to: predict whether a target access point for connecting to the network has an active session with the computing device when the computing device is disconnected from the target access point; when the uncleared session is predicted, send a clearing request to the target access point to clear the active session; and connect to the target access point.

Additional examples disclosed herein are directed to a method comprising: identifying a target access point for connecting to a network; predicting whether the target access point for connecting to the network has an active session with the computing device when the computing device is disconnected from the target access point; when the active session is predicted, sending a clearing request to the target access point to clear the active session; and connecting to the target access point.

Additional examples disclosed herein are directed to a non-transitory computer-readable medium storing a plurality of computer-readable instructions executable by a controller of a computing device, wherein execution of the instructions configures the controller to: predict whether a target access point for connecting to a network has an active session with the computing device when the computing device is disconnected from the target access point; when the uncleared session is predicted, send a clearing request to the target access point to clear the active session; and connect to the target access point.

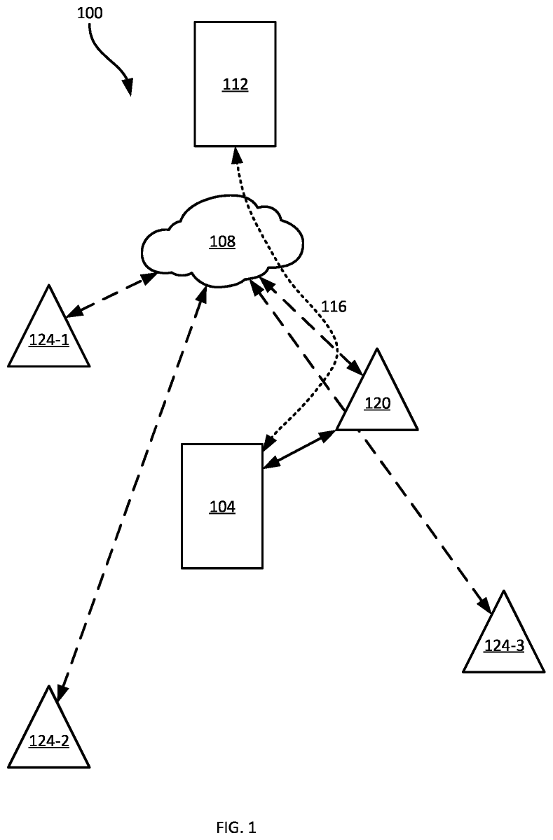

FIG. 1 depicts a system 100 for connecting to a target access point in accordance with the teachings of this disclosure. The system 100 includes a computing device 104 (also referred to herein as simply the device 104) connected to a network 108. The device 104 may communicate with a second computing device 112 via a link 116 which traverses the network 108. In some examples, the device 112 may be remote from the device 104 and the link 116 may therefore additionally traverse one or more wide-area networks such as the Internet, mobile networks and the like.

The device 104 may be a mobile computing device such as a handheld computer, a mobile phone, a tablet, a barcode scanner, or the like. In other examples, the device 104 may be a fixed computing device, such as a desktop computer, a workstation, or the like. As noted above, the device 104 is connected to the network 108, which may be deployed for wireless communications within a facility, such as a transportations and logistics facility, a warehouse, retail establishment, or other facility. Accordingly, the network 108 may be a wireless local area network (WLAN) deployed by one or more access point. In the present example, four example access points, a home access point 120, and three foreign access points 124-1, 124-2, and 124-3 are depicted. In other examples, the network 108 may include more or fewer access points.

In particular, the device 104 may be currently serviced by the wireless access point 120 to connect to the network 108. The wireless access point 120 may be referred to hereinafter as home access point 120, which the device 104 is currently/was most recently connected to for connection to the network 108. In some circumstances, the connection between the device 104 and the home access point 120 may be severed, for example due to network congestion, low network quality, missed beacons from the home access point 120 by the device 104, and the like. When the device 104 detects disconnection from the home access point 120 and/or the network 108, the device 104 may determine a target access point to which to connect to reconnect to the network 108. The target access point may be the same home access point 120 to which the device 104 was previously connected. However, based on the manner of disconnection from the home access point 120, the home access point 120 may still store an active session to the device 104. Accordingly, if the device 104 sends an association request to the home access point 120 while a session remains active, the home access point 120 may reject the association request and initiate an association comeback timer, during which requests from the device 104 will be rejected by the home access point 120.

Thus, in accordance with the present disclosure, after identifying a target access point, the device 104 may first assess the target access point to predict whether the target access point has an active session with the device 104. For example, the device 104 may base the prediction on the identity of the target access point and a previously connected access point of the device 104, as well as various network factors contributing to the disconnection of the device 104 from the network 108, as described in greater detail below. If the target access point has a predicted active session with the device 104, the device 104 may take steps to clear the active session, as further described herein, before connecting to the target access point to reduce the likelihood of triggering the association comeback timer at the target access point.

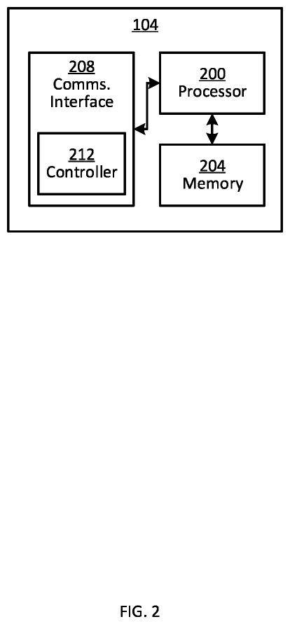

Turning now to FIG. 2, certain internal components of the computing device 104 are illustrated. The device 104 includes a processor 200 interconnected with a non-transitory computer-readable storage medium, such as a memory 204. The memory 204 includes a combination of volatile memory (e.g. Random Access Memory or RAM) and non-volatile memory (e.g. read only memory or ROM, Electrically Erasable Programmable Read Only Memory or EEPROM, flash memory). The processor 200 and the memory 204 may each comprise one or more integrated circuits. The memory 204 stores computer-readable instructions for execution by the processor 200, including one or more applications which, when executed, configure the processor 200 to perform the various functions of the device 104.

The device 104 further includes a communications interface 208 enabling the device 104 to exchange data with other computing devices, such as the device 112. The communications interface 208 is interconnected with the processor 200. The communications interface 208 includes a controller 212, and one or more antennas, transmitters, receivers, or the like (not shown), to allow the device 104 to communicate with other computing devices such as the device 112 via the link 116.

The communications interface 208 may further be configured to communicate via a second communications protocol. For example, the second communications protocol may be Bluetooth, another short-range or other suitable peer-to-peer communications protocol. The device 104 may therefore establish secondary communication links directly to other computing devices deployed nearby. In the present example, the communications interface 208 may be configured for multiple types of communications, while in other examples, the device 104 may include a second communications interface for the peer-to-peer communications protocol.

The controller 212 may be a micro-controller, a micro-processor, or other suitable device capable of executing computer-readable instructions to control the components, such as the antennae, transmitters, receivers, and the like, of the communications interface 208 to perform the functionality described herein. The controller 212 may comprise one or more integrated circuits and may include and/or be interconnected with a non-transitory computer-readable storage medium storing computer-readable instructions which when executed configure the controller 212 and/or the communications interface 208 to perform the functionality described herein.

The device 104 may further include one or more input and/or output devices (not shown) suitable to allow an operator to interact with the device 104. The input devices may include one or more buttons, keypads, touch-sensitive display screens or the like for receiving input from an operator. The output devices may further include one or more display screens, sound generators, vibrators, or the like for providing output or feedback to an operator.

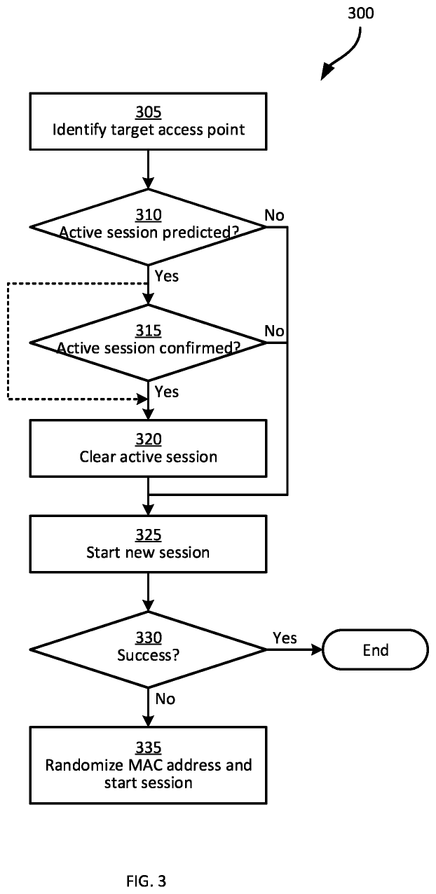

Turning now to FIG. 3, the functionality implemented by the device 104 will be discussed in greater detail. FIG. 3 illustrates a method 300 of connecting to a target access point in accordance with the present disclosure. The method 300 will be discussed in conjunction with its performance in the system 100, and particularly by the communications interface 208 and the controller 212 of the device 104. In particular, the method 300 will be described with reference to the components of FIGS. 1 and 2. In other examples, the method 300 may be performed by the processor 200 rather than the controller 212, and/or by other suitable devices.

The method 300 is initiated at block 305, where the device 104 identifies a target access point for connecting (or reconnecting) to the network 108 when the computing device is disconnected from the network 108. In the present example, the device 104 may identify the home access point 120 as the target access point. For example, the device 104 may perform a scan or the like to identify the access point from which the device 104 detects the strongest signal.

At block 310, after identifying a target access point to which to connect, the device 104 predicts whether the target access point has an active session with the device 104. For example, the device 104 may generate the prediction based on the target access point identifier and an identifier of a most recent access point, as well as network and/or other connectivity parameters experienced by the device 104 at or around the time of disconnection from the network 108.

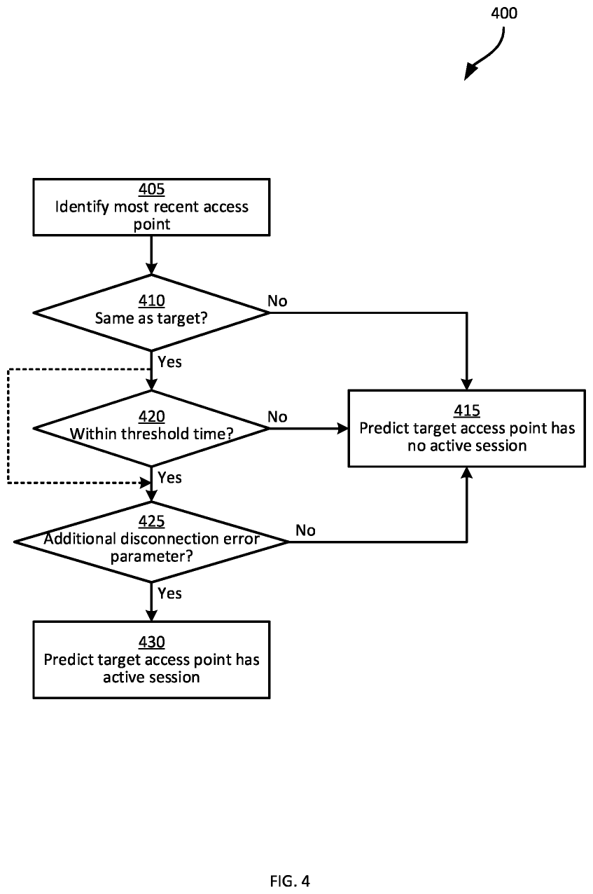

For example, referring to FIG. 4, an example method 400 of predicting whether the target access point has an active session with the device 104 is illustrated.

At block 405, the device 104 identifies a most recent access point. For example, the device 104 may store an identifier of an access point upon initial connection to a new access point. This identifier may remain stored until the device 104 connects to a new access point. Accordingly, the stored access point may be designated by the device 104 as the most recent access point; that is, the access point most recently used to connect to the network 108 or another network.

At block 410, the device 104 compares the most recent access point to the target access point to determine whether they are the same. For example, the device 104 may compare identifiers of the most recent access point and the target access point. Thus, for example, if the device 104 is temporarily disconnected from the network 108, and in particular, the home access point 120, the device 104 may subsequently determine that the home access point 120 remains the best access point for connecting to the network 108, and hence the target access point and the most recent access point are the same.

If, at block 410, the device 104 determines that the most recent access point is not the same as the target access point, the device 104 proceeds to block 415. At block 415, the device 104 may predict that the target access point does not have an active session with the device 104 and return to the method 300.

If, at block 410, the device 104 determines that the most recent access point is the same as the target access point, then the device 104 proceeds to block 420. At block 420, the device 104 may determine whether the device 104 was disconnected from the most recent access point within a threshold period prior to initiation of the method 300. For example, if, based on network properties, the home access point 120 is expected to clear its active sessions once per day, the threshold period may be twenty-four hours. Thus, if the device 104 was most recently connected to the home access point 120 a day or a week prior to identifying the home access point 120 as the target access point, the determination at block 420 is negative, and the device 104 may proceed to block 415. In particular, at block 415, the device 104 may expect that the home access point 120 has likely cleared the active session with the device 104, and hence predict that the target access point does not have an active session with the device 104.

If the device 104 determines that the device 104 was disconnected within the threshold period, then the device 104 may not be able to predict that the target access point does not have an active session with the device 104 and hence the device 104 may proceed to block 425.

In other examples, if the home access point 120 is not expected to clear active sessions unless actively instructed, the device 104 may skip block 420 and proceed directly from block 415 to block 425.

At block 425, the device 104 determines whether any additional disconnection error parameters, such as network or connectivity parameters may have contributed to an improper disconnection or dissociation from the most recent access point.

For example, conditions which may have contributed to an improper disconnection or dissociation of the device 104 from the target access point may include: the device 104 experiencing a basic service set (BSS) loss within a threshold period prior to disconnection from the most recent access point, the device 104 missing a threshold number of beacons from the most recent access point within a predefined period prior to disconnection from the most recent access point, channel congestion to the most recent access point being above a threshold level, the device 104 identifying a lack of receipt of an acknowledgement to a prior clearing request from the most recent access point, a lack of network activity from the most recent access point for a threshold amount of time, and the like. In other examples, other parameters and/or conditions or combinations thereof may also serve as predictors of an improper connection or dissociation of the device 104 from the target access point. For example, various radio parameters, such as signal strength, transmission data rates, and the like, may not meet a threshold condition which may serve as a disconnection parameter.

If, at block 425, the device 104 determines that no conditions were detected which may have contributed to an improper dissociation from the target access point, the device 104 may proceed to block 415. At block 415, the device 104 may subsequently conclude that since no conditions would likely have contributed to an improper dissociation from the target access point, the prior disconnection from the most recent access point was completed successfully. Accordingly, the device 104 may predict that the target access point does not have an active session with the device 104.

If, at block 425, the device 104 detects an additional condition which may have contributed to an improper dissociation from the target access point, the device 104 proceeds to block 430. At block 430, the device 104 may predict that the target access point has an active session with the device 104. The device 104 may then return to the method 300.

Returning to FIG. 3, if, at block 310, the device 104 predicts that the target access point does not have an active session with the device 104 (e.g., via performance of the method 400), then the device 104 proceeds to block 325 to initiate a new session with the target access point.

If, at block 310, the device 104 predicts that the target access point does have an active session with the device 104, then the device 104 may proceed to block 315. At block 315, the device 104 may verify or confirm the predicted active session at the target access point.

For example, to confirm the active session with the target access point, the device 104 may send a confirmation query (e.g., a security access (SA) query) directly to the target access point. The device 104 may identify its media access control (MAC) address in the confirmation query and receive an affirmative or negative response regarding an active session with the specified MAC address at the target access point. In other examples, the device 104 may send a general query to the target access point to identify the current active sessions at the target access point. The device 104 may then receive, as a response from the target access point, a list of devices or device identifiers with which the target access point has active sessions and determine if the target access point has an active session with the device 104 based on the list.

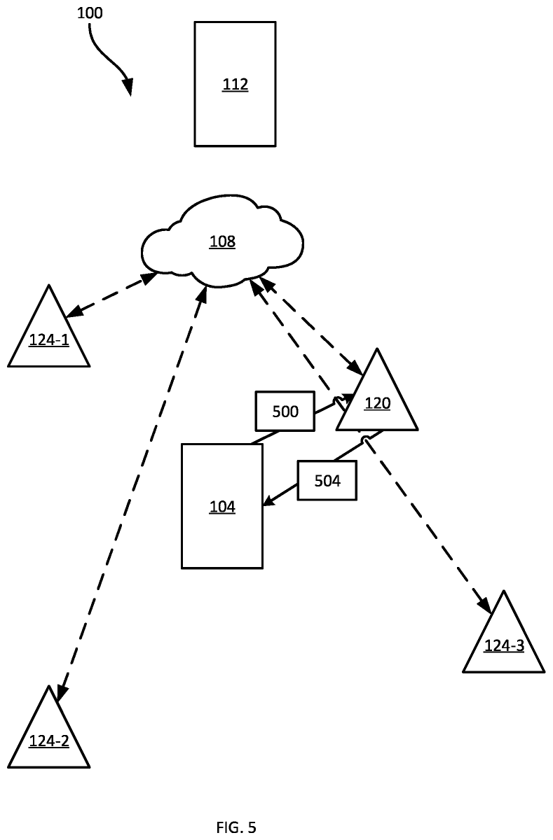

For example, referring to FIG. 5, a schematic diagram of an exchange between the device 104 and the home access point 120 as the target access point to confirm the active session at the home access point 120 is depicted. In response to predicting, at block 310, that the home access point 120 has an active session with the device 104, the device 104 may send a confirmation query 500 to the home access point 120 to confirm whether or not the home access point 120 does have an active session recorded with the device 104.

The home access point 120 returns a response 504. The response 504 may include a list of device identifiers (e.g., MAC addresses) with which the home access point 120 has active sessions recorded. In other examples, if the confirmation query 500 was an explicit request for confirmation of an active session with the device 104, as identified by the MAC address of the device 104 for example, then the response 504 may be an affirmative or a negative answer.

In other examples, the list of devices or device identifiers with which the access points 120 and 124 of the network 108 have active sessions may be otherwise publicly available without requiring connection to the network 108. The device 104 may thus access and/or retrieve the list of active sessions for the target access point and determine if the target access point has an active session with the device 104 based on the list.

In still further examples, the device 104 may establish a secondary communication link to a secondary device which is itself connected to the network 108. For example, the secondary communication link may be a Bluetooth or another suitable short-range or other peer-to-peer wireless communications protocol. The secondary device may be a suitable computing device, such as a mobile computing device including a tablet, barcode scanner, smart phone, and the like, or a computing device such as a printer, a desktop computer, or the like. Upon establishing the secondary communication link with the secondary device, the device 104 may obtain confirmation of the active session at the target access point via the secondary device. The device 104 may confirm the active session via the secondary device, for example, when the network 108 restricts queries for connected devices to devices which are already connected to the network 108. That is, the network 108 may deny a query from the device 104 since it is not connected to the network 108, and hence the device 104 may use the secondary device as a proxy or relay to confirm whether the target access point has an active session recorded.

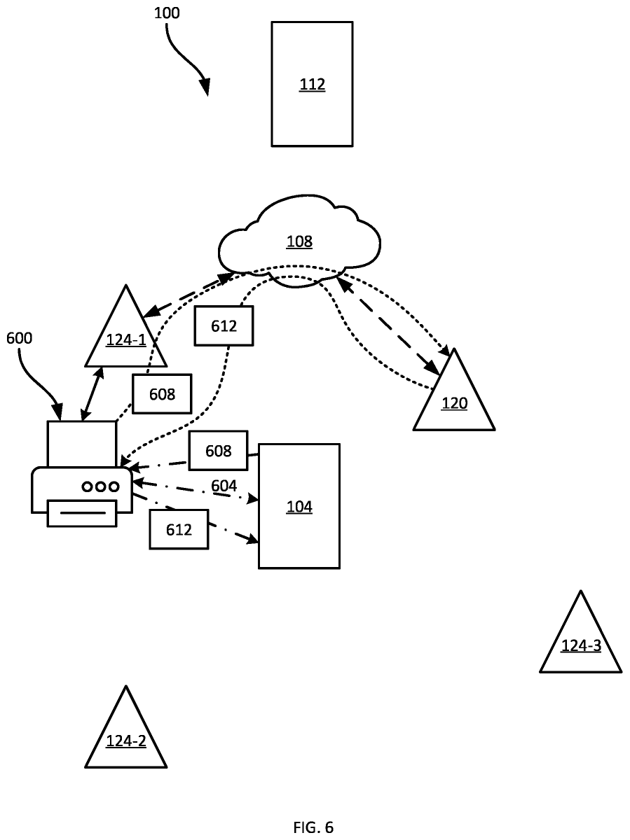

For example, referring to FIG. 6, a schematic diagram of another example exchange between the device 104 and the home access point 120 to confirm the active session at the home access point 120 is depicted. In particular, in the present example, the system 100 further includes a secondary device 600 connected to the network 108, for example via the access point 124-1.

The device 104 may establish a secondary communications link 604 with the secondary device 600, for example via Bluetooth or another suitable peer-to-peer communications protocol. The device 104 may then send a request 608 via the communications link 604 to the secondary device 600. The request 608 may be similar to the confirmation query 500, to obtain a list of active sessions recorded at the home access point 120 (i.e., the target access point), or to directly request confirmation of an active session with the device 104 at the home access point 120. The secondary device 600 may then relay the request 608 to the home access point 120, for example via its connected access point 124-1.

In response to the request 608, the home access point 120 may provide a response 612, similar to the response 504. That is, the response 612 may include a list of device identifiers (e.g., MAC addresses) with which the home access point 120 has active sessions recorded, or an affirmative or negative answer as to the existence of an active session with the device 104 specifically. The secondary device 600 may receive the response 612 from the home access point 120 via its connected access point 124-1. The secondary device 600 may then relay the response 612 to the device 104. The device 104 may then confirm the predicted active session at the home access point 120 based on the response 612.

Returning to FIG. 3, if, at block 315, the device 104 does not confirm the predicted active session at the target access point, then the device 104 may conclude that there is no active session at the target access point, and may proceed to block 325 to initiate a new session with the target access point.

If, at block 315, the device 104 confirms the predicted active session at the target access point, then the device 104 proceeds to block 320. In some examples, the device 104 may proceed from block 315 directly to block 320 without first verifying or confirming the prediction that the target access point has an active session with the device 104.

At block 320, the device 104 sends a clearing request to the target access point to clear the predicted or confirmed active session at the target access point. For example, the device 104 may send a deauthorization request to the target access point. Additionally, the device 104 may wait for an acknowledgement of the clearing request from the target access point to confirm that the active session at the target access point has been successfully cleared.

At block 325, the device 104 connects to the target access point. In particular, having cleared previous active sessions, the device 104 may send a request to initiate a new session with the target access point.

At block 330, if the device 104 has successfully initiated a new session at block 325, then the method 300 ends.

If the device 104 has failed to initiate a new session at block 325 and has, for example, received a rejection from the target access point, then the device 104 proceeds to block 335. At block 335, in response to the failure to connect to the target access point, the device 104 may randomize its MAC address and send a request to initiate a new session using the randomized MAC address. In particular, if the new session is determined to have failed at block 330, then the device 104 may assume that the home access point 120 has initiated the association comeback timer and hence new session request from the regular MAC address of the device 104 will be rejected. Accordingly, the new session using the randomized MAC address may be used to connect to the home access point 120 sooner rather than waiting for the association comeback timer to expire.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device comprising:
a wireless communications interface configured to connect to a network deployed by one or more access points;
a controller for the wireless communications interface, the controller configured to:
predict whether a target access point for connecting to the network has an active session with the computing device when the computing device is disconnected from the target access point;
when the active session is predicted, send a clearing request to the target access point to clear the active session; and
connect to the target access point.

2. The computing device of claim 1, wherein, to predict whether the target access point has the active session, the controller is configured to:
determine that a most recent access point is the target access point; and
detect a disconnection error parameter.

3. The computing device of claim 2, wherein the disconnection error parameter is selected from the group consisting of:
the computing device experiencing a basic service set loss;
the computing device missing a threshold number of beacons;
channel congestion above a threshold level;
lack of receipt of an acknowledgement to a prior clearing request;
lack of network activity for a threshold amount of time; and
a radio parameter not meeting a threshold condition.

4. The computing device of claim 1, wherein, prior to sending the clearing request, the controller is configured to confirm the active session at the target access point.

5. The computing device of claim 4, wherein to confirm the active session at the target access point, the controller is configured to send a confirmation query to the target access point.

6. The computing device of claim 4, wherein to confirm the active session at the target access point, the controller is configured to:
establish a secondary communication link to a secondary device connected to the network; and
request confirmation of the active session from the secondary device.

7. The computing device of claim 1, wherein the controller is further configured to:
in response to a failure to connect to the target access point, randomize a media access control address of the computing device; and
connect to the target access point using the randomized media access control address.

8. A method in a computing device, the method comprising:
identifying a target access point for connecting to a network;
predicting whether the target access point for connecting to the network has an active session with the computing device when the computing device is disconnected from the target access point;
when the active session is predicted, sending a clearing request to the target access point to clear the active session; and
connecting to the target access point.

9. The method of claim 8, wherein predicting whether the target access point has the active session comprises:
determining that a most recent access point is the target access point; and
detecting a disconnection error parameter.

10. The method of claim 9, wherein the disconnection error parameter is selected from the group consisting of:
the computing device experiencing a basic service set loss;
the computing device missing a threshold number of beacons;
channel congestion above a threshold level;
lack of receipt of an acknowledgement to a prior clearing request;
lack of network activity for a threshold amount of time; and
a radio parameter not meeting a threshold condition.

11. The method of claim 8, further comprising, prior to sending the clearing request, confirming the active session at the target access point.

12. The method of claim 11, wherein confirming the active session at the target access point comprises sending a confirmation query to the target access point.

13. The method of claim 11, wherein confirming the active session at the target access point comprises:
establishing a secondary communication link to a secondary device connected to the network; and
requesting confirmation of the active session from the secondary device.

14. The method of claim 8, further comprising:
in response to a failure to connect to the target access point, randomizing a media access control address of the computing device; and
connecting to the target access point using the randomized media access control address.

15. A non-transitory computer-readable medium storing a plurality of computer-readable instructions executable by a controller of a computing device, wherein execution of the instructions configures the controller to:
predict whether a target access point for connecting to a network has an active session with the computing device when the computing device is disconnected from the target access point;
when the active session is predicted, send a clearing request to the target access point to clear the active session; and
connect to the target access point.

16. The non-transitory computer-readable medium of claim 15, wherein, to predict whether the target access point has the active session, the instructions configure the controller to:
determine that a most recent access point is the target access point; and
detect a disconnection error parameter.

17. The non-transitory computer-readable medium of claim 16, wherein the disconnection error parameter is selected from the group consisting of:
the computing device experiencing a basic service set loss;
the computing device missing a threshold number of beacons;
channel congestion above a threshold level;
lack of receipt of an acknowledgement to a prior clearing request;
lack of network activity for a threshold amount of time; and
a radio parameter not meeting a threshold condition.

18. The non-transitory computer-readable medium of claim 15, wherein the instructions further configure the controller to, prior to sending the clearing request, confirm the active session at the target access point.

19. The non-transitory computer-readable medium of claim 18, wherein to confirm the active session at the target access point, the instructions configure the controller to send a confirmation query to the target access point.

20. The non-transitory computer-readable medium of claim 18, wherein to confirm the active session at the target access point, the instructions configure the controller to:
establish a secondary communication link to a secondary device connected to the network; and
request confirmation of the active session from the secondary device.

21. The non-transitory computer-readable medium of claim 15, wherein instructions further configure the controller to:
in response to a failure to connect to the target access point, randomize a media access control address of the computing device; and
connect to the target access point using the randomized media access control address.
